(19) United States
(12) Patent Application Publication
(10) Pub. No.: US 2024/0388993 A1
(43) Pub. Date: Nov. 21, 2024

(54) CONTROL APPARATUS, CONTROL METHOD, AND NON-TRANSITORY COMPUTER-READABLE STORAGE MEDIUM

(71) Applicant: CANON KABUSHIKI KAISHA, Tokyo (JP)

(72) Inventor: YOICHI MAEDA, Kanagawa (JP)

(21) Appl. No.: 18/785,169

(22) Filed: Jul. 26, 2024

Related U.S. Application Data
(63) Continuation of application No. PCT/JP2023/003632, filed on Feb. 3, 2023.

(30) Foreign Application Priority Data
Feb. 9, 2022 (JP) 2022-018846

(51) Int. Cl. H04W 40/22; H04W 48/16; H04W 84/04

(52) U.S. Cl. CPC H04W 40/22; H04W 48/16; H04W 84/047

(57) ABSTRACT

A control apparatus of an IAB (Integrated Access and Backhaul) network performs: obtaining a plurality of types of dynamic information indicating a communication status of at least one IAB node for relaying connection between an IAB donor and a predetermined IAB node in the IAB network, the at least one IAB node being connectable to the predetermined IAB node; selecting at least one type of the dynamic information, out of the plurality of types of the obtained dynamic information, based on a slice type to be supported by the predetermined IAB node; and controlling a communication path between the predetermined IAB node and the IAB donor in accordance with the selected at least one type of the dynamic information.

### CROSS-REFERENCE TO RELATED APPLICATIONS

This application is a Continuation of International Patent Application No. PCT/JP2023/003632, filed Feb. 3, 2023, which claims the benefit of Japanese Patent Application No. 2022-018846 filed Feb. 9, 2022, both of which are hereby incorporated by reference herein in their entirety.

### BACKGROUND OF THE INVENTION

### Field of the Invention

The present invention relates to a control apparatus, a control method, and a program.

### Background Art

In 3GPP (3rd Generation Partnership Project), standardization of IAB (Integrated Access and Backhaul) technology as a backhaul communication technology has been progressing. The IAB technology is a technology that simultaneously uses millimeter-wave radio communication in the 28-GHz band, which is used for access communication between base stations and user equipments (UEs), also as backhaul communication (PTL1).

In backhaul communication using the IAB technology, restoration and improvement of communication status by switching a communication path have been studied in order to prepare for deterioration of the radio environment or a failure between an IAB donor, which is equivalent to a base station, and an IAB node, which is equivalent to a relay station (PTL2). PTL2 discloses that if the communication environment of an already established communication path deteriorates, an IAB node for supporting a network slice is selected, and the communication path is switched.

### CITATION LIST

### Patent Literature

PTL1: Japanese Patent Laid-Open No. 2019-534625

PTL2: International Publication No. 2020/031269

Here, in PTL2, the IAB donor selects a path based only on the slice type requested by the UE. In such cases, the requested slice type may not be able to be supported due to, for example, an increase in the hop count resulting from an update of network topology, an increase in the processing load of the IAB node, and/or a change in the number of connected terminals.

### SUMMARY OF THE INVENTION

In view of the foregoing issue, the present invention aims to control the communication path in accordance with the communication status of connectable IAB nodes.

In response to the above issue, a control apparatus according to the present invention is a control apparatus of an IAB (Integrated Access and Backhaul) network, and includes: obtaining unit configured to obtain dynamic information indicating a communication status of at least one IAB node for relaying connection between an IAB donor and a predetermined IAB node in the IAB network, the at least one IAB node being connectable to the predetermined IAB node; and path control unit configured to select at least one type of information included in the dynamic information obtained by the obtaining unit and corresponding to a slice type to be supported by the predetermined IAB node, and controlling a communication path between the predetermined IAB node and the IAB donor in accordance with the selected information.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram showing an example of a backhaul communication system according to an embodiment.

FIG. 2 is a hardware functional block diagram of an IAB donor 101 according to the embodiment.

FIG. 3 is a software functional block diagram of the IAB donor 101 according to the embodiment.

FIG. 4 is a flowchart illustrating a method for determining a new connection destination according to the embodiment.

FIG. 5A is a flowchart illustrating a method for determining a new connection destination when a URLLC slice is requested according to Embodiment 1.

FIG. 5B is a flowchart illustrating a method for determining a new connection destination when a URLLC slice is requested according to Embodiment 1.

FIG. 6 shows an example of a connection candidate list for an IAB node 105 according to Embodiment 1.

FIG. 7 shows examples of NSSAI lists of the IAB donor 101 and IAB nodes 102 to 106 according to the embodiment.

FIG. 8 shows examples of dynamic information lists managed by the IAB donor 101 according to the embodiment.

FIG. 9A is a sequence diagram illustrating establishment of a connection to a connection destination path according to Embodiment 1.

FIG. 9B is a sequence diagram illustrating establishment of a connection to a connection destination path according to Embodiment 1.

FIG. 10 is a diagram showing a topology after a new communication path is connected according to Embodiment 1.

FIG. 11 is a flowchart illustrating a method for determining a new connection destination when an eMBB slice is requested according to Embodiment 2.

FIG. 12 is a diagram showing a topology after a new communication path is connected according to Embodiment 2.

FIG. 13 is a flowchart illustrating a method for determining a new connection destination when an MIoT slice is requested according to Embodiment 3.

FIG. 14 is a diagram showing a topology after a new communication path is connected according to Embodiment 3.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In backhaul communication using the IAB technology, relay devices called IAB nodes relay communication from an IAB donor, which is equivalent to a conventional base station. An IAB node can form communication links with a plurality of other IAB nodes to form a network tree with the IAB donor as a starting point, thereby expanding the area in which the IAB donor can provide network access.

In the IAB technology, BAP (Backhaul Adaptation Protocol) is used to perform control between the IAB donor and the IAB nodes and between the IAB nodes. BAP is defined as a protocol mainly for routing data between a plurality of IAB nodes.

Further, in the IAB technology, study has been progressing on introduction of the concept of network slicing, which virtually provides network slices that meet different requirements in a common network in response to reception of a slice request signal from a connected user equipment (UE).

Already defined types of network slices include high speed and large capacity (eMBB), low latency (URLLC), and simultaneous multiple connections (MIoT). For example, study has been conducted on a mechanism in which network slices provided by a base station are notified, each UE can select or request a network slice in accordance with its purpose, and the base station responds to enable the UE to use the requested network slice. Here, eMBB is an abbreviation of enhanced Mobile BroadBand. URLLC is an abbreviation of Ultra-Reliable and Low Latency Communications, and MIoT is an abbreviation of Massive Internet of Things.

For example, high-throughput communication is required in eMBB, and it is thus possible that an IAB node that supports eMBB is required to reserve an uplink or downlink data buffer. Further, for example, low-latency communication is required in URLLC, and it is possible that an IAB node requesting URLLC is required to reduce the hop count to the IAB donor. Further, for example, a large number of UEs need to be connected in MIT, and there are cases where the total number of UEs in a communication path needs to be below a threshold.

Here, in backhaul communication using the IAB technology, there are cases where some IAB nodes are unable to satisfy slice requirements due to insufficient capacity of an IAB donor or IAB node connected upstream, or due to deterioration of the communication status. In response to this issue, a technology has been proposed by which an IAB node that does not have a function corresponding to the requested slice type is identified, and an IAB node that satisfies the requested slice type is selected as a switching destination, thereby realizing appropriate path switching and multipath connection.

However, even if an IAB node that forms a communication path satisfies the slice type required by a UE, the aforementioned slice requirements may not be satisfied due to dynamically changing communication status.

In the following embodiments, communication systems are described in which a communication path capable of supporting a requested slice type is set by obtaining dynamic information related to the dynamically changing communication status, selecting a piece of information from the dynamic information based on the requested slice type, and controlling the communication path.

### EMBODIMENT 1

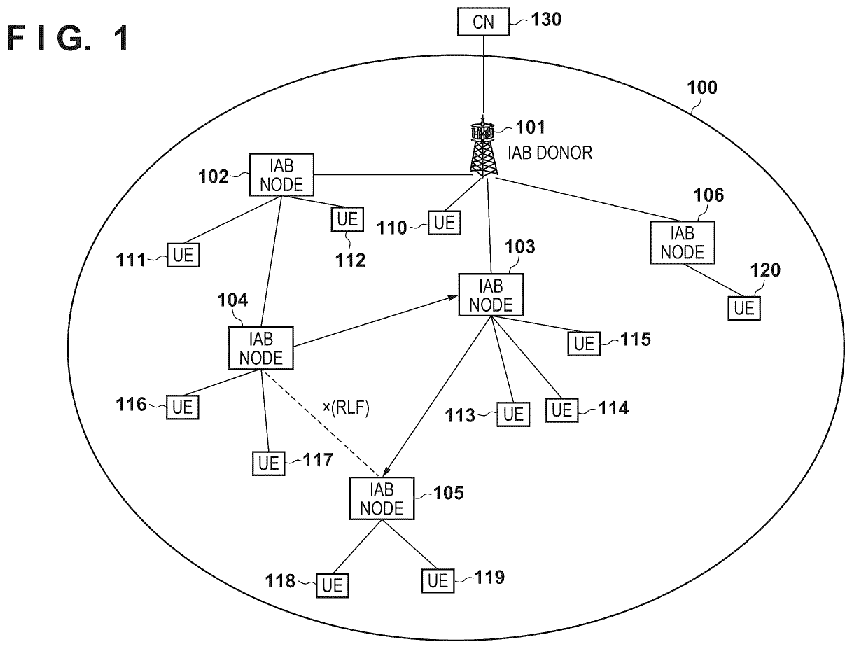

FIG. 1 is a diagram showing an example of a radio communication system 100 according to the present embodiment. The radio communication system 100 includes a backhaul network (IAB network) that includes an IAB donor 101 that provides connection to a CN (Core Network) 130, and IAB nodes 102 to 106. Here, the CN performs various types of processing such as authentication of UEs 110 to 120, which are terminals, packet transfer control, and establishment of a communication channel.

The IAB donor 101 performs centralized control on the IAB nodes 102 to 106 and forms its own coverage area. It is assumed that the IAB donor 101 determines and assigns, to each of the IAB nodes 102 to 106, the type of network slice that can be supported by the IAB node. That is, the IAB donor 101 manages information related to the type of network slice supported by each of the IAB nodes 102 to 106. The IAB donor 101 of the present embodiment manages information regarding the slice supported by each of the IAB nodes 102 to 106 in the form of an NSSAI (Network Slice Selection Assistance Information) list. If any of the slices that can be supported by the IAB nodes 102 to 106 changes, the change is notified to the IAB donor 101 by means of a BAP control message.

The BAP control message refers to a message transmitted and received in accordance with a BAP control PDU (Protocol Data Unit) format. The notification may be given using a PDU type field as control information, or any other reserved field of the BAP control message may be used.

It is assumed that the UEs 110 to 120 are executing applications using desired slices provided by the IAB nodes 102 to 106. For example, the UE 118 is executing an application requiring an eMBB slice, and the UE 119 is executing an application requiring URLLC. For example, the slices have different requirements (slice requirements); for example, eMBB requires a communication path with high throughput (large capacity) compared to URLLC, and URLLC requires a communication path with low communication latency and low packet loss rate compared to eMBB.

Here, it is assumed that in the radio communication system 100, radio quality in a radio communication area between the IAB node 104 and the IAB node 105 has deteriorated, and a link failure has occurred. In this case, the IAB node 105 no longer satisfies the requirement of only eMBB as a specific slice, and an error may occur in the application executed by the UE 118 among the UEs connected to the IAB node 105.

In such a case, the IAB node 105 detects that it no longer satisfies the slice requirements of eMBB (non-satisfaction of slice requirements) and notifies the IAB donor 101 of the change in NSSAI by means of a BAP control message. Here, non-satisfaction of the slice requirements at the IAB node 105 may be detected by the IAB donor 101 or the IAB node 105 receiving a control message indicating an eMBB slice request from the UE 118. Alternatively, non-satisfaction of the slice requirements may be determined by the IAB donor 101 or the IAB node 105 based on the quality of a signal from the IAB node 104 that is periodically measured by means of RRM (Radio Resource Management).

To restore communication with the IAB node 105 in response to a link failure occurring between the IAB nodes 104 and 105, the IAB node 104 may establish a new communication path from the IAB node 104 to the IAB node 105 via the IAB node 103 and continue communication. In such a case, the IAB node 105 may be able to continue to meet the eMBB slice request from the UE 118. However, due to an increase in the hop count resulting from the switching of the communication path, the slice requirements may no longer be satisfied, as in the case of inability to perform low-latency functions of the URLLC slice requested by the UE 119.

In such cases, to rescue an IAB node that can no longer satisfy the slice requirements requested by a UE, the IAB donor 101 determines a connection destination of the IAB node to form a new communication path and notifies the IAB node of the determined connection destination.

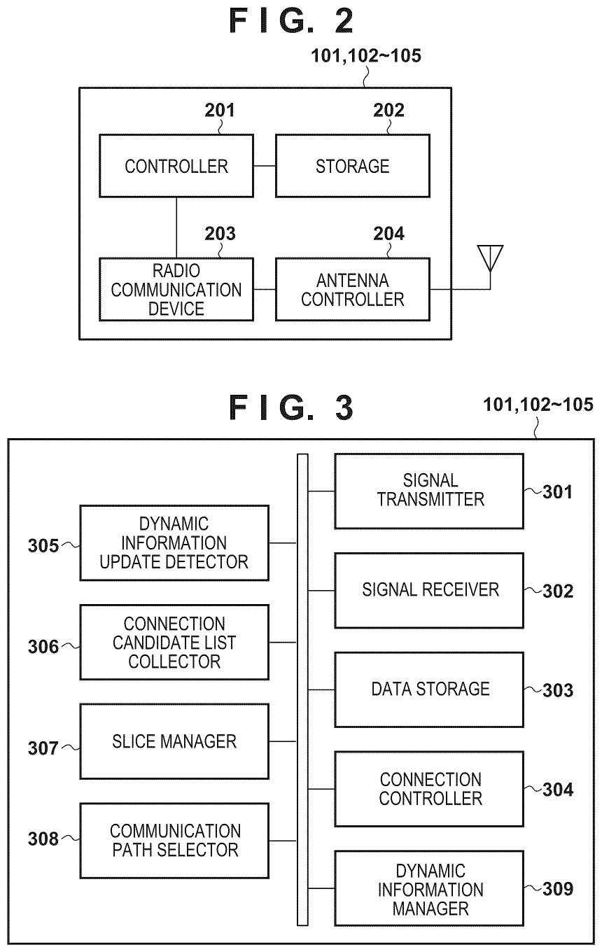

FIG. 2 is a hardware functional block diagram of the IAB donor 101 according to the present embodiment. The IAB donor 101 includes a controller 201, a storage 202, a radio communication device 203, and an antenna controller 204. Although the hardware of the IAB donor 101 is described here, the IAB nodes 102 to 106 have the same configuration.

The controller 201 controls the entire IAB donor 101 by executing a control program stored in the storage 202. The controller 201 includes a processor and a memory. The storage 202 stores various types of information, such as the control program executed by the controller 201, information related to an identifier (cell ID) of a cell provided by the IAB donor 101 and UEs connected to the IAB donor 101 or the IAB node, and routing information regarding the IAB node. Later-described operations are performed by the controller 201 executing the control program stored in the storage 202.

The radio communication device 203 is a communication device that includes a radio communication circuit for performing cellular network communication conforming to the 3GPP standard, such as LTE or 5G. The radio communication device 203 is capable of measuring the status of communication with the IAB nodes 102 to 106 and the UEs 110 to 120 in accordance with RRM and notifying the IAB donor 101 and the IAB nodes 102 to 106 of the measurement results by means of RRC. Note that RRC is an abbreviation of Radio Resource Control. RRC has functions such as connection establishment between the IAB nodes 102 to 106 and the UEs 110 to 120, admission control, RRC state management, and notification of surrounding cell information and access restrictions. It is assumed that received reference signal power and received reference signal quality of adjacent cells can be obtained as the communication status that can be measured by means of RRM, which is a function of RRC.

The antenna controller 204 controls an antenna used for radio communication performed by the radio communication device 203.

FIG. 3 is a software functional block diagram of the IAB donor 101 according to the present embodiment. The software functional blocks shown in

FIG. 3 are stored in the storage 202 and realized as a result of being executed by the controller 201. The software functional blocks include a signal transmitter 301, a signal receiver 302, a data storage 303, a connection controller 304, a dynamic information update detector 305, a connection candidate list collector 306, a slice manager 307, a communication path selector 308, and a dynamic information manager 309.

The signal transmitter 301 and the signal receiver 302 control the radio communication device 203 via the controller 201, and perform cellular network communication conforming to the 3GPP standard, such as LTE or 5G, with the IAB nodes 102 to 106 and the UEs 110 to 120.

The data storage 303 controls and manages the storage 202, which is the entity thereof, and stores and holds software itself, routing information regarding the IAB nodes 102 to 106, information related to the UEs 110 to 120, and the like. The connection controller 304 controls the antenna controller 204 via the controller 201 during radio communication.

The dynamic information update detector 305 receives RRC signals including a request to re-establish a communication path, a change in a connection path, a radio link failure notification, flow control feedback, and a handover completion notification from the IAB nodes 102 to 106, and notifies the communication path selector 308 of the received RRC signal. The dynamic information update detector 305 is a pass controller that updates dynamic information regarding the IAB nodes managed by the dynamic information manager 309.

The connection candidate list collector 306 collects and manages connection candidate lists for the IAB nodes 102 to 106. The slice manager 307 stores and manages NSSAI lists indicating slices supported by respective IAB nodes that are obtained from the IAB nodes 102 to 106 via a BAP control message.

In response to the notification from the dynamic information update detector 305, the communication path selector 308 references the connection candidate list of the IAB node 105, slice information regarding the IAB nodes 102 to 104 and the IAB donor 101, and the dynamic information manager 309, and determines a new connection destination capable of rescuing the IAB node 105. Here, being capable of rescuing the IAB node 105 means that a path can be set that is capable of achieving the requirements of the slice requested by a UE directly connected to the IAB node 105. The newly determined connection destination is notified to the IAB node 105 by means of an RRC control message. Here, the RRC control message is a message conforming to the PDU format defined by RRC, and is realized using any of the fields that indicate functions of RRC. The notification given to the IAB node 105 by means of the RRC control message may be made with NCL (Neighbor Cell List) of the new connection destination only.

The update of dynamic information regarding the IAB node 105 may be detected by receiving a URLLC slice request signal from the UE 119, or may be determined by the IAB donor 101 based on the quality of a signal from the IAB node 102 that is periodically measured by means of RRM.

The dynamic information manager 309 of the IAB donor 101 manages dynamic information, namely the hop count, free buffer capacity, and the total number of UEs in each pass regarding the IAB nodes 102 to 106. That is, dynamic information includes a plurality of types of information that vary depending on the communication status of each IAB node, and is information used by the IAB donor 101 to determine the communication status of each IAB node. Further, dynamic information may also include a processing delay time at each IAB node, the number of UEs connected to the IAB node, the maximum subframe size, the ratio of uplink (UL) transmission in a TDD pattern, and the smallest value the radio field strength within a predetermined time period, as will be described below. In this case, based on the aforementioned information received from each IAB node, the dynamic information manager 309 may use the total processing delay time on a communication path from the IAB donor to a specific IAB node, and the sum of the number of connected UEs as the dynamic information regarding the specific IAB node. Alternatively, the dynamic information manager 309 may use, based on the above information, predetermined statistics such as the smallest value of the maximum subframe size of each IAB node on a communication path, the smallest value of the ratio of UL transmission, and the smallest value of the minimum radio field strength as dynamic information regarding the specific IAB node.

Here, software of the IAB donor 101 has been described. However, the IAB nodes 102 to 106 have the same software configuration except for the dynamic information update detector 305, the connection candidate list collector 306, the slice manager 307, the communication path selector 308, and the dynamic information manager 309.

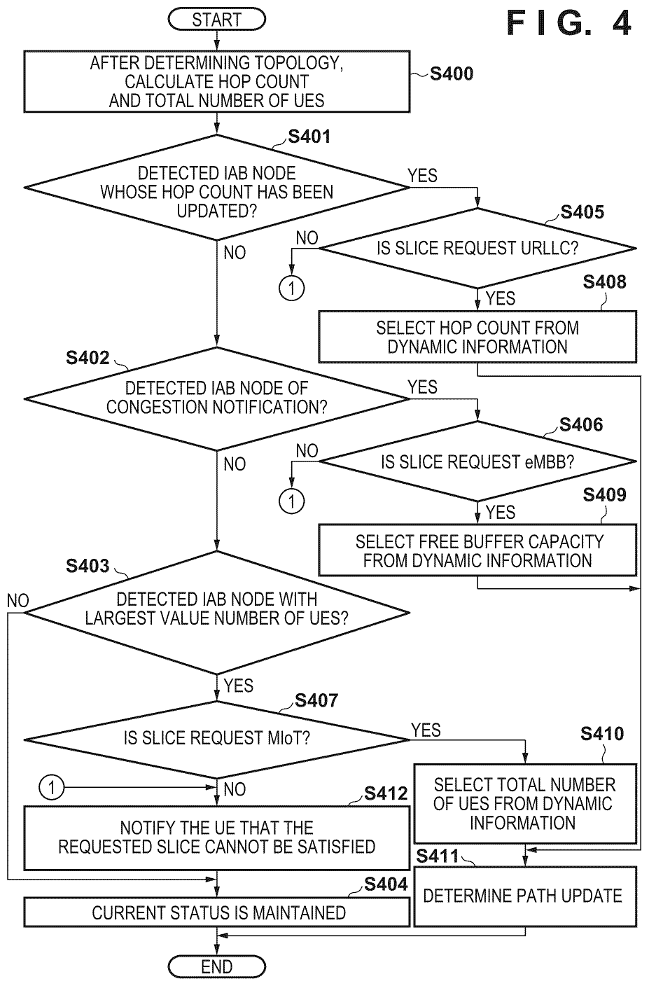

FIG. 4 is a flowchart showing an example of new path determination processing according to the present embodiment. The flowchart shown in FIG. 4 is executed by the dynamic information update detector 305 of the IAB donor 101.

In step S400, after receiving notification by means of an RRC control message to determine a network topology, the IAB donor 101 calculates the hop count and the total number of UEs of each IAB node. The IAB donor 101 also stores and manages a free buffer capacity by receiving BSR (Buffer Status Report) notified by each IAB node at a timing of receiving a data message or with polling by a parent node as a trigger.

In step S401, the IAB donor 101 checks whether the hop count of any IAB node has been updated. If the hop count of any IAB node has been updated (Yes in S401), the IAB donor 101 advances the processing to step S405 and checks whether the requested slice is URLLC. If the requested slice is URLLC, the IAB donor 101 advances the processing to step S408, determines to reference the hop count included in the dynamic information, and advances the processing to step S411 to update the path. If the requested slice is not URLLC, the IAB donor 101 advances the processing to step S412 and notifies the UE that the requested slice URLLC cannot be satisfied.

If, in step S401, the hop count of any IAB node has not been updated (No in S401), in step S402, the IAB donor 101 checks whether congestion notification has been given by means of flow control feedback from any IAB node. If, in step S402, notification of the occurrence of congestion has been given (Yes in S402), the IAB donor 101 determines whether or not the requested slice at the IAB node at which congestion has occurred is eMBB. If the requested slice is eMBB (Yes in S406), the IAB donor 101 advances the processing to step S409, determines to reference the free buffer capacity included in the dynamic information, and determines to update the path (S411). If the requested slice is not eMBB (No in S406), the IAB donor 101 advances the processing to step S412 and notifies the UE that the requested slice eMBB cannot be satisfied.

If no IAB node giving congestion notification is detected (No in S402), the IAB donor 101 advances the processing to step S403, and attempts to detect an IAB node with the number of connected UEs being a largest value (256 UEs per base station). If, in step S403, there is an IAB node with the number of UEs being the largest value, it is checked whether the requested slice is MIoT (S407). If the requested slice is MIoT (Yes in S407), the IAB donor 101 advances the processing to step S410, determines to reference the total number of UEs included in the dynamic information, and updates the path (S411). If the requested slice is not MIoT (No in S407), the IAB donor 101 advances the processing to step S412 and notifies the UE that the requested slice MIoT cannot MIoT be satisfied. Note that the types of set network slices may also include C-V2X (Cellular-Vehicle to Everything) or any other slice types in addition to high speed and large capacity (eMBB), low latency (URLLC), and simultaneous multiple connections (MIoT).

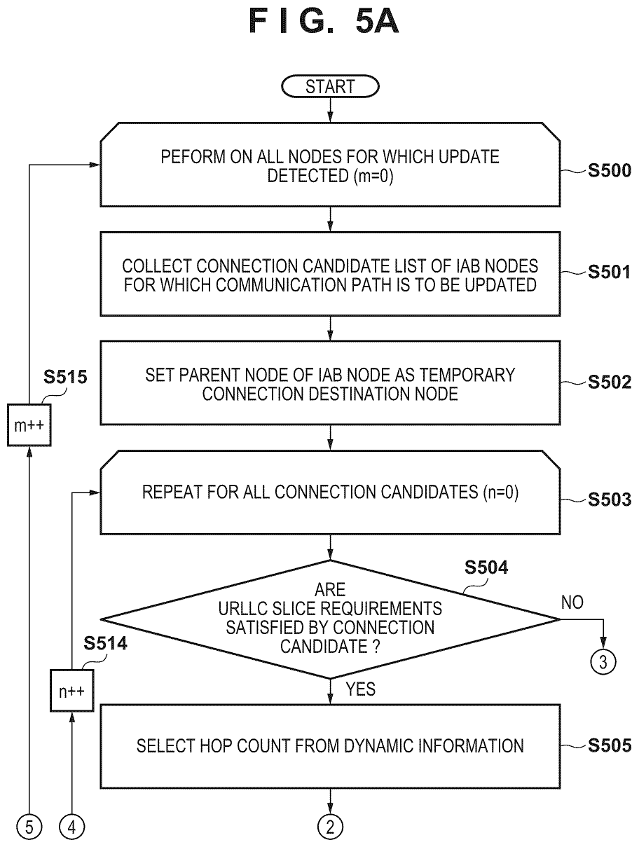

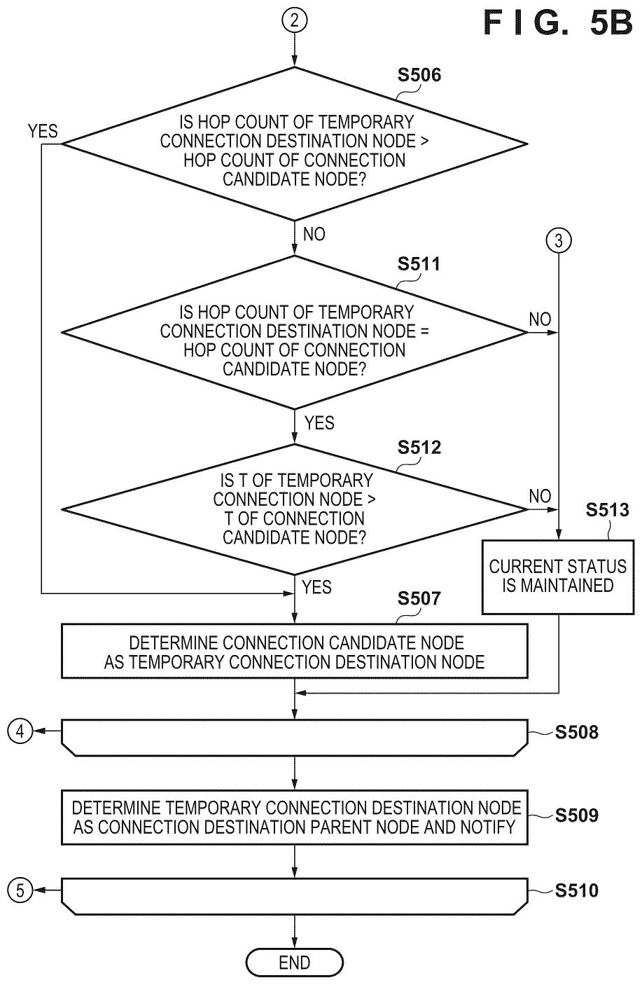

FIGS. 5A and 5B show a flowchart illustrating a method for determining a new connection destination path when the URLLC slice is requested according to Embodiment 1. The flowchart shown in FIGS. 5A and 5B is executed by the communication path selector 308 of the IAB donor 101.

In step S500, the dynamic information update detector 305 detects that the hop count, which is dynamic information regarding URLLC at the IAB node 105, has been updated based on an update of the network topology and a congestion degree, and the communication path selector 308 receives this detection result.

In step S501, the connection candidate list collector 306 collects a list of connection candidate IAB nodes (connection candidate list) that can be connected from the IAB node 105, by means of an RRC control message. In step S502, the IAB node 104, which is (was) a parent node of the IAB node 105 at the beginning of the processing, is set as a temporary connection destination IAB node. The parent node refers to a node that is located upstream of a specific node on a communication path.

Processing in steps S503 to S508 and S511 to S513 is repeated for all of the IAB nodes 102, 103, and 106 listed in the connection candidate list for the IAB node 105 at which an update of the dynamic information has been detected.

In step S504, the NSSAI list for a connection candidate IAB node n that is managed by the slice manager 307 is referenced, and it is determined whether the connection candidate IAB node n satisfies the URLLC slice requirements. If the requirements are satisfied (Yes in S504), information related to the hop count is selected from the dynamic information in step S505. If the requirements are not satisfied (No in S504), the processing proceeds to step S513, and the current status of the relevant IAB node is maintained. The processing is then repeatedly performed for the next connection candidate IAB node n. Here, “the current status being maintained” means that the communication path is not changed for the connection candidate IAB node n, i.e., the temporary connection destination IAB node is not changed.

In step S506, the hop count to the IAB donor 101 is compared between the temporary connection destination IAB node and the connection candidate IAB node. If the hop count at the temporary connection destination IAB node is larger than the hop count at the connection candidate IAB node (Yes in S506), the IAB donor 101 advances the processing to step S507 and determines the connection candidate IAB node with a smaller hop count as a temporary connection destination IAB node. If, in step S506, the hop count at the temporary connection destination node is smaller than or equal to the hop count at the connection candidate node (No in S506), the IAB donor 101 advances the processing to step S511 and determines whether the hop count at the temporary connection destination IAB node is equal to the hop count at the connection candidate node. If the hop count at the temporary connection destination node is equal to the hop count at the connection candidate node (Yes in S511), the IAB donor 101 compares delay time T in the dynamic information. The value of T here is a communication path parameter used to determine a path based on which of the temporary candidate node and the connection candidate node can reduce communication delay more when the value of the hop count is the same therebetween. The value of T may be determined by referencing the following values:
(1) node processing delay time (the total of all IAB nodes on the path);
(2) the total number of UEs (the total of all IAB nodes on the path);
(3) the sub-frame size (the largest value at each IAB node on the path);
(4) the UL ratio in the TDD pattern (the smallest value at each IAB node on the path); and
(5) the radio field strength (the smallest value at each IAB node on the path).

If, in step S511, the hop count at the temporary connection destination node is smaller than the hop count at the connection candidate IAB node, the IAB the IAB donor 101 advances the processing to step S513, and the current status of the relevant IAB node is maintained. In step S514, the IAB donor 101 references the next IAB node.

After repeating the processing for all of the connection candidate IAB nodes n, in step S509, the temporary connection destination IAB node is determined as a connection destination IAB node, and an RRC control message directing the IAB node 105 to be connected to the connection destination IAB node is transmitted to the IAB node 105.

The IAB node 105 receives the notification of the connection destination IAB node 103 with the smallest hop count from the IAB donor 101 and is connected to the new connection destination IAB node 103. This enables communication using a path with the smallest hop count.

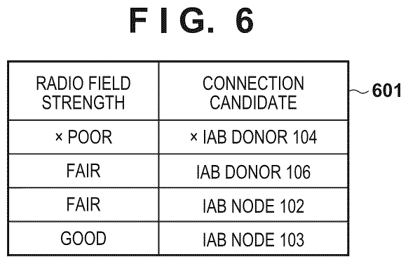

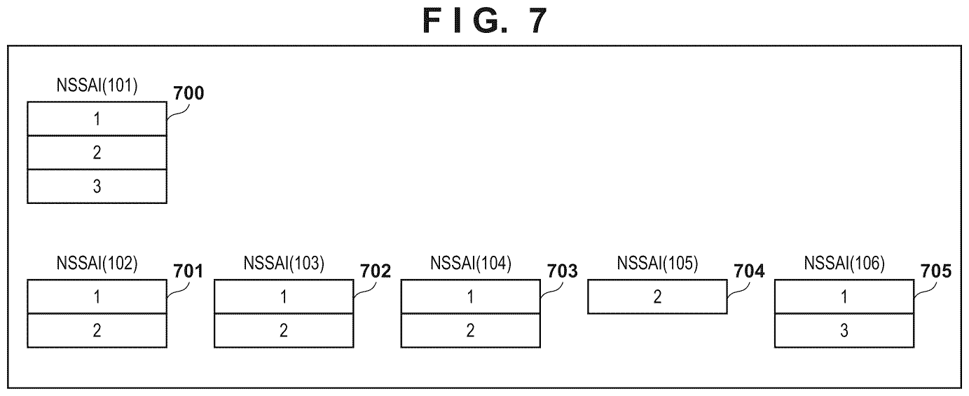

FIG. 6 shows an example of a connection candidate list for the IAB donor 105 according to Embodiment 1. A connection candidate list 601 may be transmitted as adjacent cell information by each of the IAB nodes 102, 103, and 106 via an RRC control message based on the results of RRM measurements performed by the IAB node 105, and collected and managed by the connection candidate list collector 306 of the IAB donor 101.

As another method, the IAB donor 101 may collect the results of RRM measurements at each of the IAB nodes 102 to 105 by means of an RRC control message, and generate the connection candidate list 601 by listing the IAB nodes in descending order of radio field strength, for example. Alternatively, the IAB donor 101 may collect and use NCL as connection candidate lists of the IAB nodes 102 to 106.

When considering the connection destination of the IAB node 105 based on the connection candidate list 601, the IAB node 104 is the IAB node with the highest radio field strength. However, in the case of the disconnection due to interference, the IAB node with the next highest radio strength after the IAB node 104 is the IAB node 103. Note that the radio field strength in the connection candidate list shown in FIG. 6 is classified into poor, fair, and good, but may alternatively be indicated by numerical values indicating radio field strength.

Next, description is given of processing by which the IAB donor 101 determines in the processing in steps S405 to S407 whether the IAB node 103 satisfies the slice requirements, with reference to FIG. 7 showing examples of NSSAI lists for the respective IAB nodes 102 to 106.

FIG. 7 shows examples of NSSAI lists for the IAB donor 101 and the IAB nodes 102 to 106 according to Embodiment 1.

NSSAI lists 701 to 705 are examples of slice support information regarding the IAB nodes 102 to 106 that is managed by the slice manager 307. Here, 704 denotes a list for the IAB node 105 at which an update of the hop count has been detected in step S401.

Each value in NSSAI indicates SST (Slice Service Type), namely a supportable slice type, and the values 1, 2, and 3 are associated with eMBB, URLLC, and MIoT, respectively. In the NSSAI lists 700 to 705, the IAB donor 101 supports all of the slice types eMBB, URLLC, and MIoT. The IAB nodes 102 to 104 supports SST of eMBB and URLLC. The IAB node 105 cannot provide eMBB due to the communication link failure, and supports SST of URLLC only. The IAB node 106 supports SST of URLLC and MIoT.

Note that in the above description of the example shown in FIGS. 5A and 5B, connection is made to an IAB node with the smallest hop count from the IAB donor 101 among the connection candidate IAB nodes. However, the aforementioned delay time T may be compared between IAB nodes with a hop count smaller than or equal to a predetermined threshold (first threshold). This makes it possible to select a communication path with a shorter communication delay even when factors other than the hop count have a great impact on the communication delay.

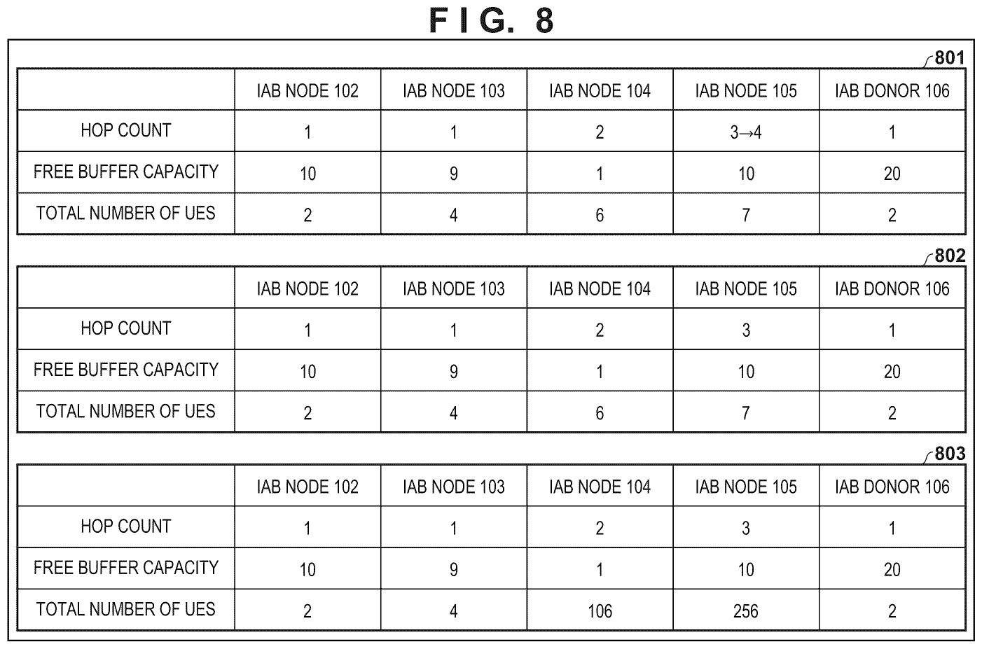

FIG. 8 shows an example of a dynamic information list regarding the IAB nodes 102 to 106 that are managed by the IAB donor 101 according to the present embodiment. The dynamic information list shown in FIG. 8 is updated by the IAB donor 101 in response to receiving notification of path switching, BSR, or the like from the IAB nodes 102 to 106, and is managed by the dynamic information manager 309.

Affected by the communication link failure between the IAB nodes 104 and 105 in FIG. 1, a new path is formed by connecting the IAB node 104 to the IAB node 105 via the IAB node 103. This update of the network topology updates the hop count serving as the dynamic information regarding the IAB node 105 in FIG. 8 from 3 to 4, and this update of the hop count is detected in step S401 in FIG. 4.

Here, the IAB node 103, which is a connection destination candidate node, is an IAB node with the smallest hop count that supports the URLLC slice requirements in step S509, and is thus selected as a connection destination to form a new communication path with the IAB node 105. It seems in NSSAI that the IAB node 105 can support URLLC as a result of the path switching due to the communication link failure, but there are cases where the functions of URLLC cannot be performed due to an increase in the delay time resulting from the increase in the hop count. In such cases, the IAB donor 101 of the present embodiment establishes a connection of a new communication path to the IAB node 105 to be rescued, i.e., that cannot satisfy the requested slice.

Here, the IAB donor 101 detects that the hop count of the IAB node 103 is 1 based on hop count information regarding the IAB node 103 shown in FIG. 8. The hop count is smallest with the current route connecting from the IAB donor 101 to the IAB node 105 via the IAB node 103, and the IAB donor 101 thus controls the IAB nodes 103 and 105 to use this communication path and sets the communication path. A communication path that satisfies the requirements of the slice type requested by a UE connected to the IAB node 105 can thus be set.

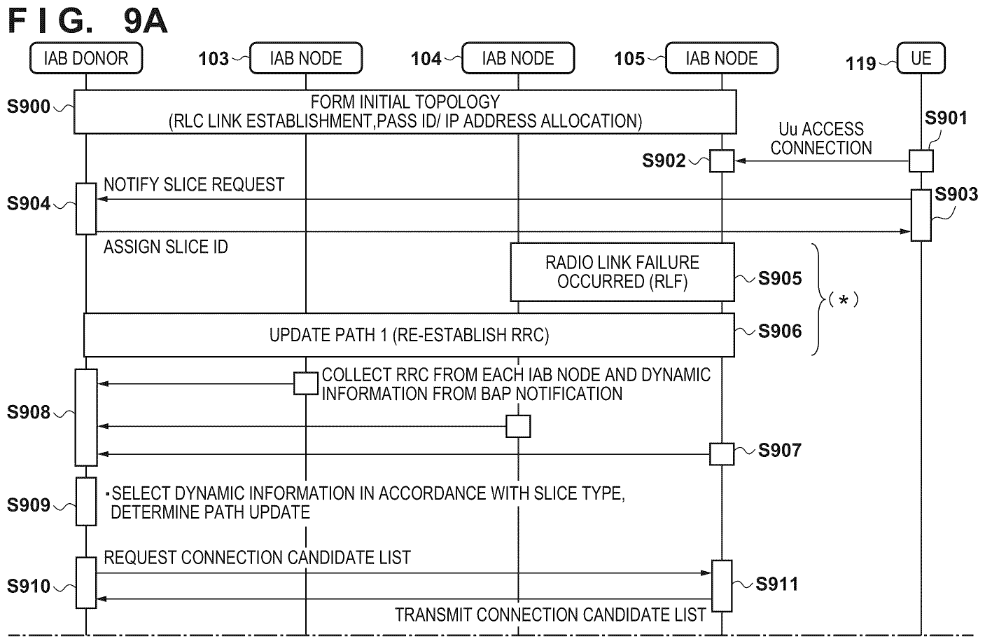

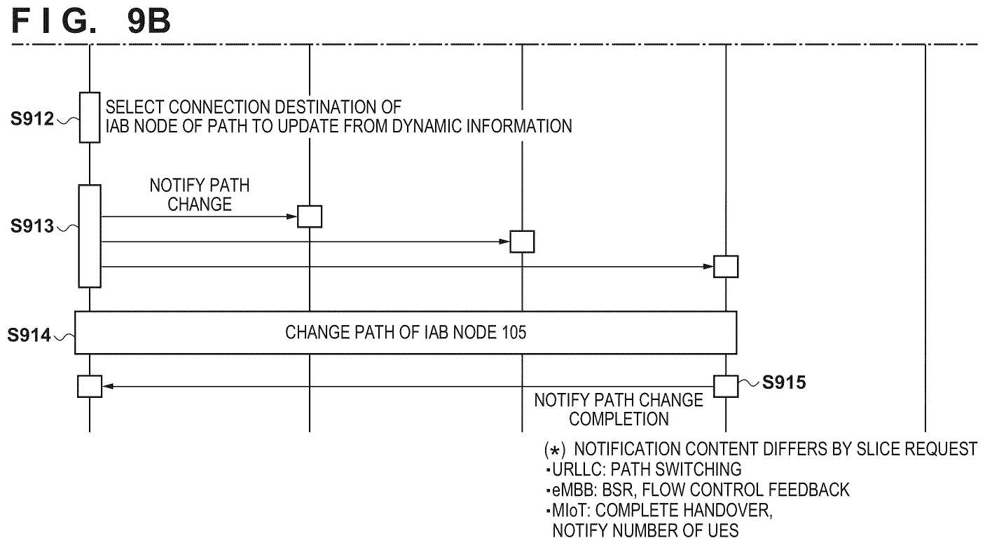

FIGS. 9A and 9B show a sequence diagram illustrating connection establishment according to the present embodiment. Description is given of an operation to establish a connection to the IAB node 105 along a new communication path.

In step S900, the IAB donor 101 establishes a path connection by, for example, assigning an IP address to each of the IAB nodes 102 to 106 in the coverage of the IAB donor 101, and forms an initial network topology. In steps S901 and S902, the UE 119 establishes a Uu access connection to the IAB node 105. If, in step S903, the UE 119 requests the URLLC slice, in step S904, the IAB donor 101 assigns the slice to the UE 119.

In step S905, the IAB nodes 104 and 105 are disconnected due to a radio link failure, and in S906, the communication path is switched to a new path with which the IAB node 105 communicates via the IAB node 103. In step S907, the

IAB nodes 103 to 105 notify the IAB donor 101 of the switching of the communication path, using RRC messages.

In step S908, the IAB donor 101 that has received the notification from the IAB nodes causes the dynamic information update detector 306 to determine whether the dynamic information has been updated. In the present embodiment, the path switching is notified by each IAB node using an RRC message. In one example, the switching of the communication path may alternatively be notified using any other message, such as congestion notification by means of flow control feedback conforming to BAP, or notification of the number of UEs (handover notification by means of RRC, notification of the number of UEs accessing each IAB node using BAP notification).

In step S909, the IAB donor 101 detects an update of dynamic information by referencing the RRC and BAP message notifications received from the IAB nodes, and determines which slice the updated dynamic information corresponds to. In Embodiment 1, the hop count of the IAB node 105 is updated from 3 to 4 in step S401. It is thus determined in step S405 that the slice type is URLLC, the hop count in the dynamic information is referenced in step S408, and a path update for the IAB node 105 is determined from step S411.

In step S910, the IAB donor 101 makes a request for the connection candidate list to the IAB node 105 for which a path update has been determined, by means of an RRC message. In step S911, the IAB node 105 transmits the connection candidate list generated based on the RRM measurement results to the IAB donor 101 by means of an RRC message.

In step S912, the connection destination candidate list (S503) for the IAB node 105 is obtained in accordance with the flowchart shown in FIGS. 5A and 5B. Next, the NSSAI lists managed by the slice manager 307 and information indicating the hop count included in the dynamic information managed by the dynamic information manager 309 (S505) are selected, and the IAB node 103 with the smallest hop count is selected as a connection destination node (S509). In step S913, the IAB donor 101 notifies the IAB node 105 of the change in the communication path with the IAB node 103 by means of an RRC control message.

In step S914, the IAB node 105 establishes the new path to the IAB donor 101 via the IAB node 103. The IAB donor 101 gives an instruction of a new F1-C connection with the IAB node 105. It is assumed in the above description that each control message is transmitted and received by means of BAP and RRC, but this need not necessarily be the case. For example, the communication path may be specified by transmitting an application-layer message. In step S915, the IAB node 105 notifies the IAB donor 101 that the path update has been completed.

Thus, the communication path for the IAB node 105 that needs path switching due to an occurrence of a communication failure can be switched to a communication path that satisfies the slice requirements required by a UE connected to the IAB node 105.

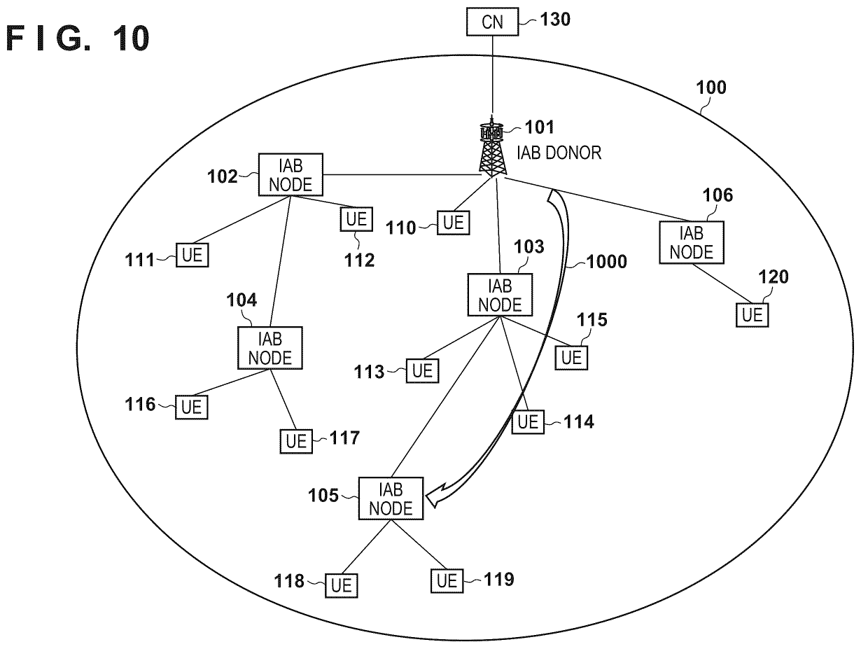

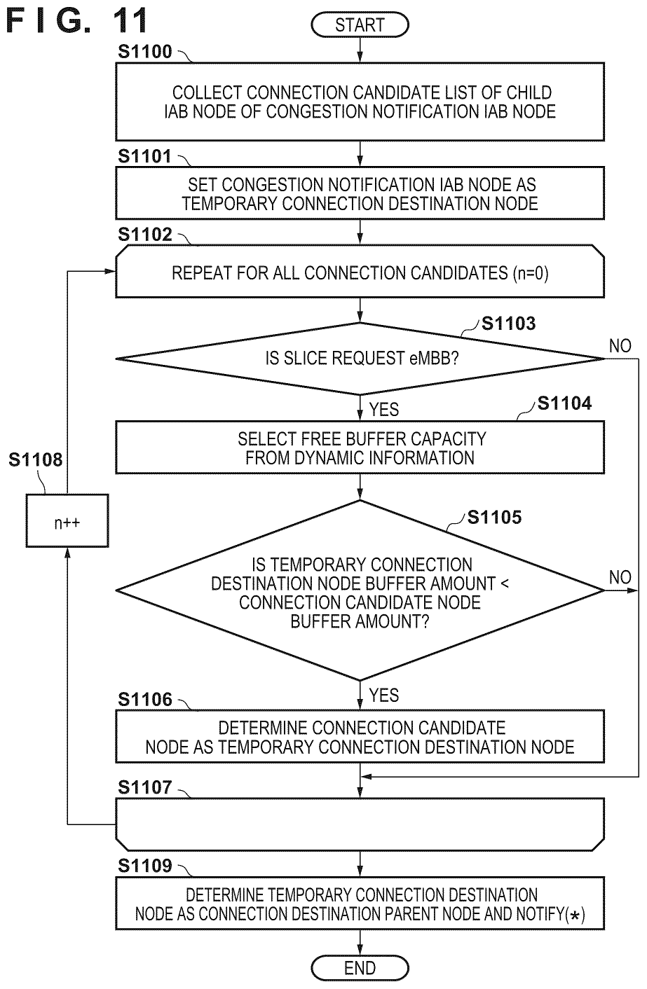

FIG. 10 is a diagram showing a topology after connecting to the new communication path according to Embodiment 1. In the radio communication system 100, the IAB node 105 can provide the URLLC slice to the UE 119 by establishing a connection to a path 1000 together with the IAB node 103 after the sequence shown in FIGS. 9A and 9B has been executed.

As described above, it is possible to support a specific slice whose requirements are not satisfied among the IAB nodes 102 to 105 as a result of a path switching due to a radio link failure, by forming a communication path with a new connection destination for the specific slice.

### EMBODIMENT 2

In Embodiment 1, description has been given of the case where a link failure occurs in the radio communication system 100 between the IAB node 105 that is requested for URLLC by a UE, and the IAB node 104, which is a parent node of the IAB node 105, and the hop count varies due to the switching of the communication path. In Embodiment 2, description is given of a method by which, when congestion due to buffer overflow occurs at the IAB node 104, which serves as a parent node of the IAB node 105, a new connection destination capable of supporting the slice requested by UE 118, namely eMBB.

Note that the same configurations, functions, and processing as those of Embodiment 1 are assigned the same reference numerals, and detailed description thereof is omitted.

FIG. 11 is a flowchart illustrating determination of a new communication path when the eMBB slice is requested according to the present embodiment. The same configurations, functions, and processing shown in FIGS. 2 to 9B described in Embodiment 1, excluding FIG. 4, are applied. It is assumed in Embodiment 2 that a radio link failure has not occurred between the IAB nodes 104 and 105. Dynamic information regarding the IAB nodes is the same as that denoted by 802 in FIG. 8.

In step S1100, after receiving flow control feedback notification from the IAB node 104 in a congested state, the IAB donor 101 collects the connection candidate list for the IAB node 105 located downstream of the IAB node 104 on the communication path.

In step S1101, the IAB node 104 in a congested state is set as a temporary connection destination IAB node. Steps S1102 to S1107 are repeated for the number n of connection candidate IAB nodes (S1108). In step S1103, it is determined whether the slice requested by the UE is eMBB. If the requested slice is eMBB (Yes in S1103), the processing proceeds to step S1104, and information indicating free buffer capacity (buffer information) is selected from the dynamic information in 802.

In step S1105, if the free buffer capacity of the connection candidate IAB node is larger than the free buffer capacity of the temporary connection destination IAB node, the processing proceeds to step S1106, and the connection candidate IAB node with the larger free buffer capacity is determined as the temporary connection destination IAB node. If the free buffer capacity of the connection candidate IAB node is smaller than or equal to the free buffer capacity of the temporary connection destination IAB node, the processing proceeds to step S1107, and the determination of the free buffer capacity is performed for another connection candidate IAB node.

After repeating step S1108 for all of the connection candidate IAB nodes n, in step S1109, the temporary connection destination IAB node is determined as a connection destination IAB node. The IAB node 105 is instructed, by means of an RRC message, to be connected to the IAB node with the largest free buffer capacity among the connection candidate IAB nodes. In the present embodiment, the IAB node 106 that has the largest free buffer capacity in the dynamic information denoted by 803 in FIG. 8 is selected as the IAB node with the largest free buffer capacity.

The IAB node 105 receives notification of the connection destination IAB node 106 with the largest free buffer capacity from the IAB donor 101, and is connected to the new connection destination IAB node 106 and can then be provided with a communication path with the largest free buffer capacity.

Note that the IAB node 105 may form a multipath connection by establishing a new communication path with the IAB node 106 while maintaining the communication path with the IAB node 104.

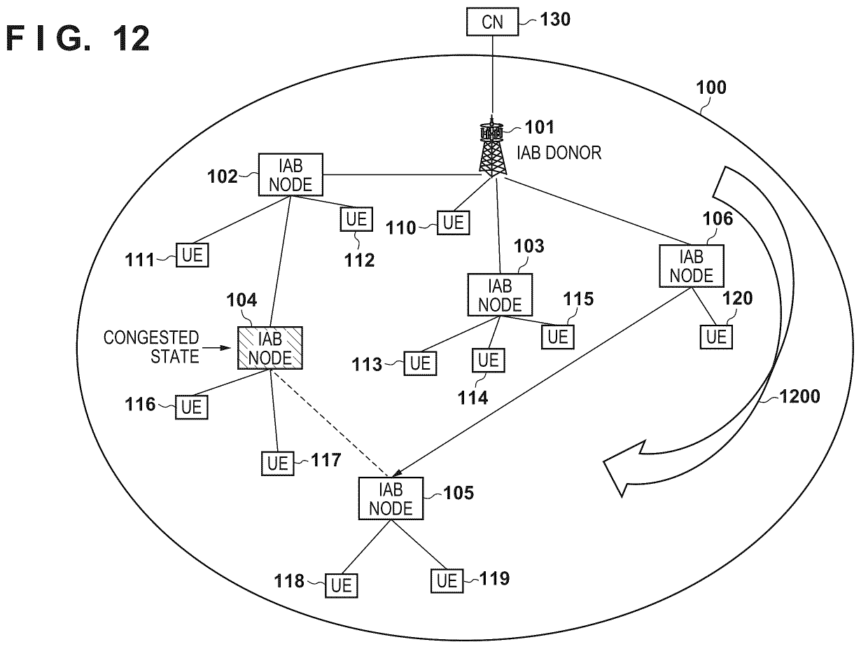

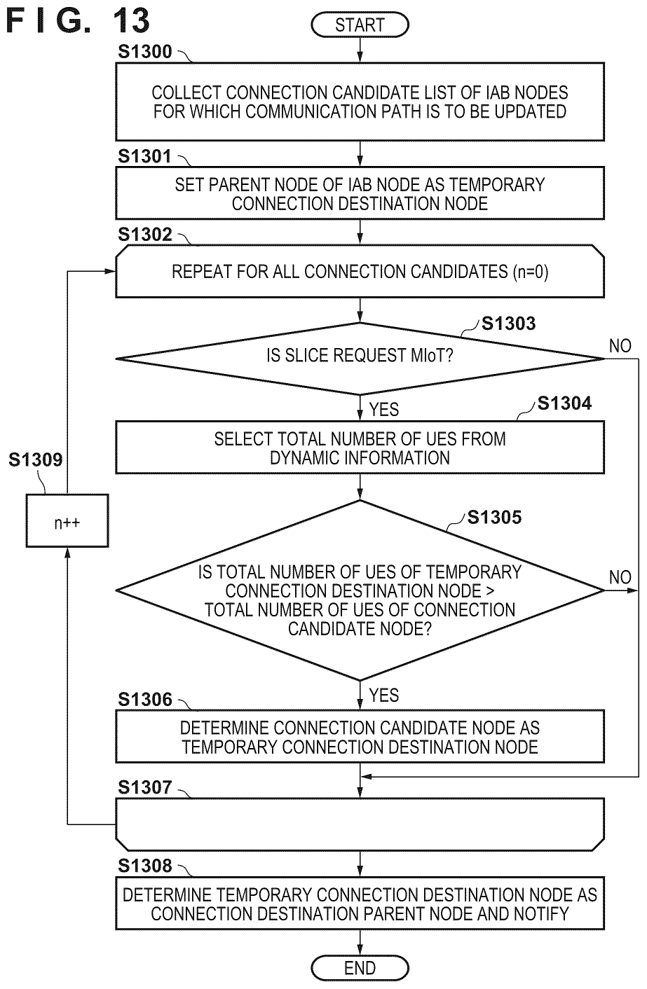

FIG. 12 shows a topology after connecting to the new communication path according to the present embodiment. In the radio communication system 100, the IAB node 104 can be provided with a communication path by which the eMBB slice is supported for the UE 119 by establishing a connection to a multipath 1200 with the IAB donor 101 through the flowchart shown in FIGS. 9A and 9B.

It is assumed in the description of the present embodiment that connection is to be made to the IAB node with the largest free buffer capacity. However, connection may alternatively be made to an IAB node with a free buffer capacity larger than or equal to a predetermined threshold (second threshold). In this case, if two or more IAB nodes with a free buffer capacity larger than or equal to the predetermined threshold are present, the IAB node 105 may determine which of those IAB nodes connection is to be made to, based on any other piece of dynamic information, such as the ratio of UL transmission.

### EMBODIMENT 3

In Embodiment 3, description is given of processing by which, when the number of UEs connecting to the IAB node 105 exceeds a predetermined threshold, a new connection destination capable of supporting the slice requested by the UE 118, namely MIoT.

FIG. 13 is a flowchart for determining a new communication path when the MIoT slice is requested according to the present embodiment. Here, it is assumed as a prerequisite that the same figures as FIGS. 2 to 9B described in Embodiment 1, excluding FIG. 4, can be applied, and a radio link failure has not occurred between the IAB nodes 104 and 105. Dynamic information regarding each IAB node is the same as that denoted by 803 in FIG. 8. Note that in the present embodiment, communication can be provided to a total of 256 UEs for each communication path that supports MIoT.

In step S1300, after receiving an RRC signal or BAP notification from the IAB node 105 notifying that the number of connected UEs has exceeded a threshold, the IAB donor 101 collects the connection candidate list for the IAB node 105. In step S1301, the IAB node 104, which serves as a parent node of the IAB node 105 whose number of connected UEs exceeds a threshold is set as a temporary connection destination IAB node.

Processing in steps S1302 to S1307 is repeatedly performed for the number n of connection candidate nodes (S1309). In step S1303, it is determined whether the slice requested by the connection candidate IAB node is MIoT. If the requested slice is MIoT, the processing proceeds to step S1304, and information indicating the total number of UEs (number-of-users information) is selected from the dynamic information in S801.

In step S1305, if the total number of UEs of the connection candidate IAB node is smaller than the total number of UEs of the temporary connection destination IAB node, the processing proceeds to step S1306, and the connection candidate IAB node with the smaller total number of UEs is determined as the temporary connection destination IAB node. If the total number of UEs of the connection candidate IAB node is larger than or equal to the total number of UEs of the temporary connection destination IAB node, the processing proceeds to step S1307, and the determination is performed for another connection candidate IAB node.

After repeating S1309 for all of the connection candidate IAB nodes n, in step S1308, the temporary connection destination IAB node is determined as a connection destination IAB node, and the IAB node 105 is notified that the IAB node with the smallest total number of UEs is to be selected, by means of an RRC control message. The IAB node 106 has the smallest total number of UEs based on the total number of UEs in S801.

The IAB node 105 that has received notification of the connection destination IAB node 106 with the smallest total number of UEs from the IAB donor 101 is connected to the new connection destination IAB node 106 and provided with a path with the smallest total number of UEs.

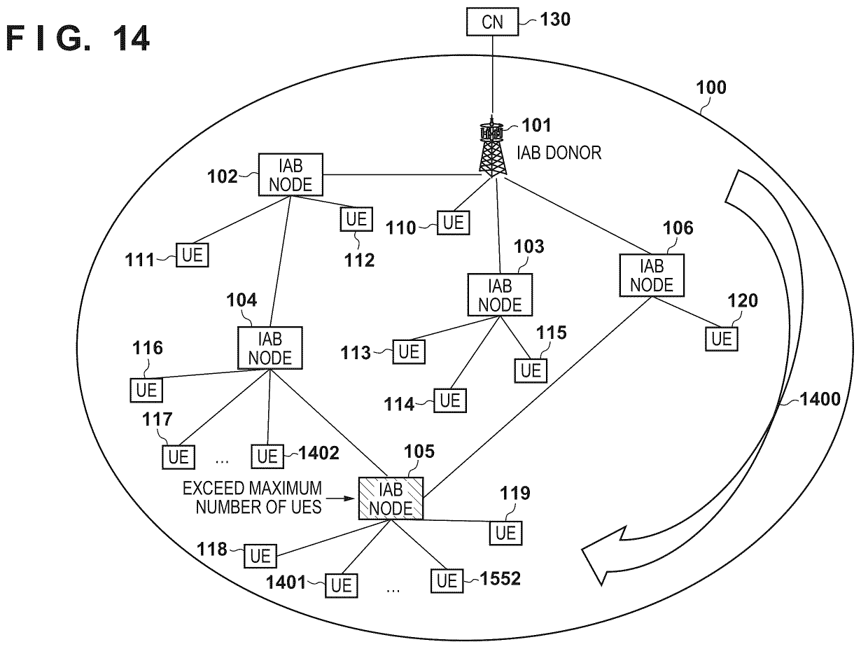

FIG. 14 shows a topology after connecting to the new communication path according to Embodiment 3. If 106 UEs are already connected to the IAB node 104 and IAB nodes located upstream of the IAB node 104 on the communication path, only 150 UEs can additionally be connected to the IAB node 105, which is located downstream of the IAB node 104 on the communication path. In this case, in the radio communication system 100, a connection to the IAB donor 101 along the multipath 1400 can be established for the IAB node 104 through the flowchart shown in FIGS. 9A and 9B. This makes it possible to provide a UE 1552 with communication supporting MIoT by allocating the UE 1552, which is connected to the IAB node 105, to a communication path supporting the MIoT slice via the IAB node 106.

Note that, in one example, the IAB donor 101 may alternatively switch the communication path based on the number of UEs connectable to a predetermined IAB node. For example, in the example shown in FIG. 14, 100 UEs are connected upstream of the IAB node 104, and two UEs are connected upstream of the IAB node 106. In this case, the IAB donor 101 may determine a connection destination out of the connection candidate IAB nodes based on the total number of UEs connected to a connection candidate IAB node and IAB nodes upstream thereof, for the IAB node 105 with the number of UEs connected thereto that exceeds a threshold. Thus, in the case where the number of UEs connectable to the entire communication path is predetermined, communication supporting the MIoT slice type can be provided to a newly connecting UE by switching the connection destination of a downstream IAB node. Note that it is assumed in the present embodiment that connection is made to an IAB node with the smallest total number of connected UEs or the largest number of connectable UEs. However, it may alternatively be possible to be connected to an IAB node with a total number of UEs smaller than or equal to a predetermined threshold (third threshold) or the number of connectable UEs larger than or equal to a predetermined threshold. In this case, if two or more IAB nodes with a total number of UEs smaller than or equal to the predetermined threshold are present, it may be determined which of those IAB nodes the IAB node 105 is to be connected to, based on any other type of dynamic information.

According to the present invention, the communication path can be controlled in accordance with the communication status of connectable IAB nodes.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

In Embodiments 1 to 3, path switching has been described. However, if RLF (Radio Link Failure) is notified, rather than deterioration of communication quality, by means of a BAP control message, a multipath connection may be established to a newly determined connection destination by maintaining the original communication path.

In Embodiments 1 to 3, a single slice is rescued for the IAB nodes 102 to 106. However, if requirements of more than one slice cannot be satisfied within a predetermined time period, a slice requested by the largest number of UEs may be rescued preferentially. Further, if the slice requested by the larger number of UEs cannot be rescued, a new communication path may be selected so as to rescue a slice requested by the next largest number of UEs.

In the description of the embodiments, for URLLC, a temporary connection destination node is set based on the hop count to the IAB donor, and the delay time is compared if the hop count is the same. In one example, the IAB donor may store a type of dynamic information to be selected and a priority thereof in association with each slice type in the storage 202. In this case, in the processing in step S505, dynamic information of the predetermined type may be selected based on the slice type, and comparison may be performed in order of priority.

In the description of the embodiments, the IAB donor 101 includes the connection controller 304 to the dynamic information manager 309 shown in FIG. 3. However, in one example, those modules may alternatively be provided on a network node on the core network side, or may be provided in any of the nodes in the radio communication system 100.

1. A control apparatus of an IAB (Integrated Access and Backhaul) network, comprising:
obtaining unit configured to obtain a plurality of types of dynamic information indicating a communication status of at least one IAB node for relaying connection between an IAB donor and a predetermined IAB node in the IAB network, the at least one IAB node being connectable to the predetermined IAB node;
selection unit configured to select at least one type of the dynamic information, out of the plurality of types of the dynamic information obtained by the obtaining unit, based on a slice type to be supported by the predetermined IAB node; and
path control unit configured to control a communication path between the predetermined IAB node and the IAB donor in accordance with the at least one type of the dynamic information selected by the selection unit.

2. The control apparatus according to claim 1, wherein
the plurality of types of the dynamic information includes hop count information indicating a hop count from the IAB donor to the at least one connectable IAB node, and
if the slice type is URLLC (Ultra-Reliable and Low Latency Communications),
the selection unit selects the hop count information as the at least one type of the dynamic information, and
the path control unit switches the communication path such that connection is made to an IAB node with a smallest hop count from the IAB donor, out of the at least one connectable IAB node.

3. The control apparatus according to claim 1, wherein
the plurality of types of the dynamic information includes hop count information indicating a hop count from the IAB donor to the at least one connectable IAB node, and
if the slice type is URLLC (Ultra-Reliable and Low Latency Communications),
the selection unit selects the hop count information as the at least one type of the dynamic information, and
the path control unit sets the communication path such that the predetermined IAB node is connected to an IAB node with the hop count indicated by the hop count information being smaller than or equal to a first threshold, out of the at least one connectable IAB node.

4. The control apparatus according to claim 1, wherein
the plurality of types of the dynamic information includes buffer information indicating a free buffer capacity of the at least one connectable IAB node, and
if the slice type is eMBB (enhanced Mobile BroadBand),
the selection unit selects the buffer information as the at least one type of the dynamic information, and
the path control unit switches the communication path such that the predetermined IAB node is connected to an IAB node with a largest free buffer capacity, out of the at least one connectable IAB node.

5. The control apparatus according to claim 1, wherein
the plurality of types of the dynamic information includes buffer information indicating a free buffer capacity of the at least one connectable IAB node, and
if the slice type is eMBB (enhanced Mobile BroadBand),
the selection unit selects the buffer information as the at least one type of the dynamic information, and
the path control unit sets the communication path such that the predetermined IAB node is connected to an IAB node with the free buffer capacity indicated by the buffer information being larger than or equal to a second threshold, out of the at least one connectable IAB node.

6. The control apparatus according to claim 1, wherein
the plurality of types of the dynamic information includes number-of-users information indicating the number of user equipments connected to the at least one connectable IAB node, and
if the slice type is MIoT (Massive Internet of Things),
the selection unit selects the number-of-users information as the at least one type of the dynamic information, and
the path control unit switches the communication path such that connection is made to an IAB node with a smallest number of connected user equipments, out of the at least one connectable IAB node.

7. The control apparatus according to claim 1, wherein
the plurality of types of the dynamic information includes number-of-users information indicating the number of user equipments connected to the at least one connectable IAB node, and
if the slice type is MIoT (Massive Internet of Things),
the selection unit selects the number-of-users information as the at least one type of the dynamic information, and
the path control unit sets the communication path such that the predetermined IAB node is connected to an IAB node with the number of user equipments indicated by the number-of-users information being smaller than or equal to a third threshold, out of the at least one connectable IAB node.

8. The control apparatus according to claim 1, wherein
the at least one connectable IAB node is at least one IAB node supporting the slice type.

9. The control apparatus according to claim 1, further comprising
first receiving unit configured to receive a slice request signal making a request for a communication path supporting a slice type from a user equipment connected to the predetermined IAB node,
wherein if the first receiving unit receives the slice request signal, the path control unit specifies an IAB node to which the predetermined IAB node is to be connected.

10. The control apparatus according to claim 9, further comprising
notification unit configured to notify the user equipment that has transmitted the slice request signal that the slice type is not supportable if the first receiving unit receives the slice request signal and the path control unit determines that no communication path supports the slice type requested by the slice request signal.

11. The control apparatus according to claim 1, further comprising
second receiving unit configured to receive, from the predetermined IAB node, an RRC (Radio Resource Control) signal including: a request to re-establish a communication path; notification of a radio link failure; and flow control feedback,
wherein if the second receiving unit receives the RRC signal, the obtaining unit obtains the dynamic information, and the path control unit controls the communication path between the IAB donor and the predetermined IAB node so as to support the slice type that is supportable by the predetermined IAB node.

12. The control apparatus according to claim 11, wherein
if the second receiving unit receives the RRC signal from a plurality of IAB nodes within a predetermined time period, the path control unit preferentially controls a communication path of an IAB node with a larger number of connected user equipments.

13. The control apparatus according to claim 1, wherein
the selection unit selects more than one type of the dynamic information, out of the plurality of types of the dynamic information, based on the slice type to be supported by the predetermined IAB node, and
the path control unit controls the communication path based on the more than one type of the dynamic information selected by the selection unit.

14. The control apparatus according to claim 13, further comprising
storage unit configured to store information in which the slice type is associated with a priority in determination regarding a communication path for each of the plurality of types of the dynamic information,
wherein the path control unit controls the communication path by selecting dynamic information in descending order of the priority, out of the more than one type of the dynamic information selected by the selection unit.

15. A control method to be executed by a control apparatus of an IAB (Integrated Access and Backhaul), comprising:
obtaining a plurality of types of dynamic information indicating a communication status of at least one IAB node for relaying connection between an IAB donor and a predetermined IAB node in the IAB network, the at least one IAB node being connectable to the predetermined IAB node;
selecting at least one type of the dynamic information, out of the plurality of types of the dynamic information obtained, based on a slice type to be supported by the predetermined IAB node; and
controlling a communication path between the predetermined IAB node and the IAB donor in accordance with the at least one type of the dynamic information selected.

16. A non-transitory computer-readable storage medium storing a program causing a control apparatus of an IAB (Integrated Access and Backhaul) network to execute steps of:
obtaining a plurality of types of dynamic information indicating a communication status of at least one IAB node for relaying connection between an IAB donor and a predetermined IAB node in the IAB network, the at least one IAB node being connectable to the predetermined IAB node;
selecting at least one type of the dynamic information, out of the plurality of types of the dynamic information obtained, based on a slice type to be supported by the predetermined IAB node; and
controlling a communication path between the predetermined IAB node and the IAB donor in accordance with the at least one type of the dynamic information selected.
